(19) United States
(12) Patent Application Publication
(10) Pub. No.: US 2023/0274182 A1
(43) Pub. Date: Aug. 31, 2023

(54) SYSTEM AND METHOD FOR ASSESSING AND BALANCING SERVICE LEVEL AGREEMENTS FOR FACILITY INFRASTRUCTURE

(71) Applicant: AT&T Intellectual Property I, L.P., Atlanta, GA (US)

(72) Inventors: Louis Alexander, Franklin, NJ (US); Eric Zavesky, Austin, TX (US); David Crawford Gibbon, Lincroft, NJ (US); Jianxiong Dong, Pleasanton, CA (US)

(73) Assignee: AT&T Intellectual Property I, L.P., Atlanta, GA (US)

(21) Appl. No.: 17/681,081

(22) Filed: Feb. 25, 2022

(51) Int. Cl. G06N 20/00; G01D 9/32; G01D 1/02; G01D 9/42

(52) U.S. Cl. CPC G06N 20/00; G01D 9/32; G01D 1/02; G01D 9/42; G06Q 50/06

(57) ABSTRACT

Aspects of the subject disclosure may include, for example, a device, including a processing system including a processor; and a memory that stores executable instructions that, when executed by the processing system, facilitate performance of operations of constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query. Other embodiments are disclosed.

### FIELD OF THE DISCLOSURE

The subject disclosure relates to a system and method for assessing and balancing service level agreements for facility infrastructure.

### BACKGROUND

Locational information about facilities infrastructure is either non-existent, outdated, or unreliable. Traditionally, call before you dig (CBYD) programs require an on-site survey due to the unreliable nature of existing facilities infrastructure information.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2 is a block diagram illustrating an example, non-limiting embodiment of a system functioning within the communication network of FIG. 1 performing a method of assessing and balancing service level agreements (SLAs) for facility infrastructure in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method for evaluating facilities infrastructure reliability at a sub-neighborhood level. For example, a potential homebuyer can research the quality of the local school district and can study broadband service availability in terms of cost and speed, but there is currently no universal system for reporting broadband mean time between failure (MTBF) reporting from a national or local level for physical damage to the facilities infrastructure, from, for example, cable breaches due to storms, accidents, wildlife, etc.

In another scenario, the system can understand and react to emergencies in the area. Predictive analysis could forecast natural disasters, intentional damage, or service degradations (e.g., rolling blackout or water rationing). The system plans for and accommodates such situations without complex ex-post facto reactions after disaster occurs.

Finally, much like a connected stoplight that understands approaching and departing traffic, the system coordinates construction, remodeling, and service loss across services and localities. For example, beyond traditional permit recording (a passive registry of planned action), the system accepts action requests and plans available operation times according to the traffic, activity, and needs of the consumers and inhabitants in an area. Other embodiments are described in the subject disclosure.

One or more aspects of the subject disclosure include a device, including a processing system including a processor; and a memory that stores executable instructions that, when executed by the processing system, facilitate performance of operations of constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query.

One or more aspects of the subject disclosure include a non-transitory, machine-readable medium with executable instructions that, when executed by a processing system including a processor, facilitate performance of operations of constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query.

One or more aspects of the subject disclosure include a method of constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query.

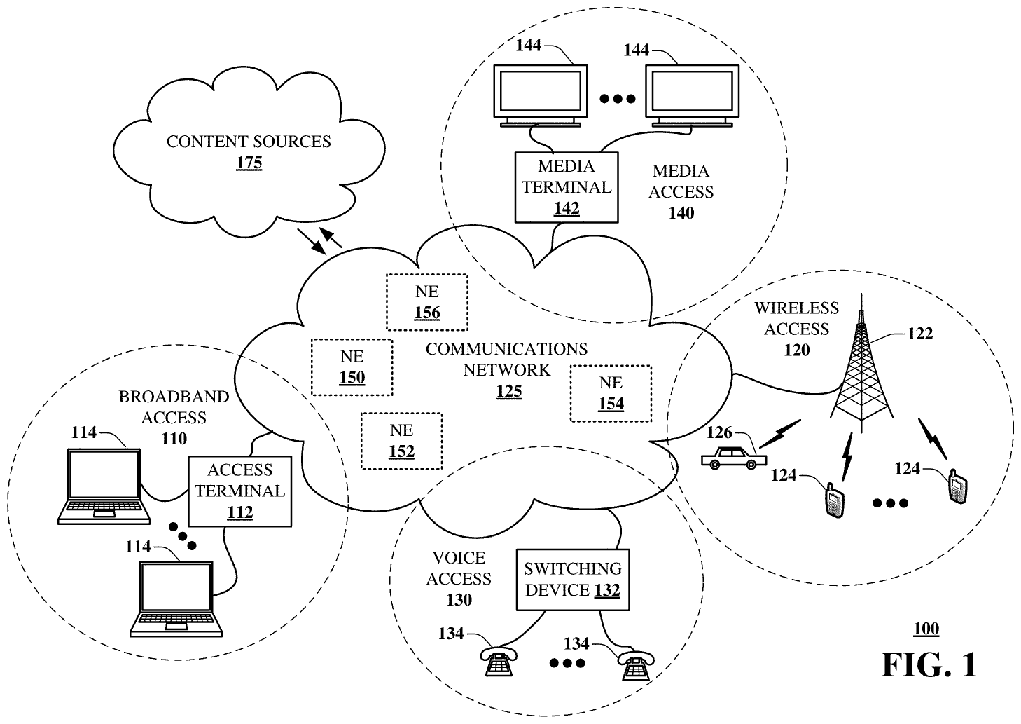

Referring now to FIG. 1, a block diagram is shown illustrating an example, non-limiting embodiment of a system 100 in accordance with various aspects described herein. For example, system 100 can facilitate in whole or in part constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

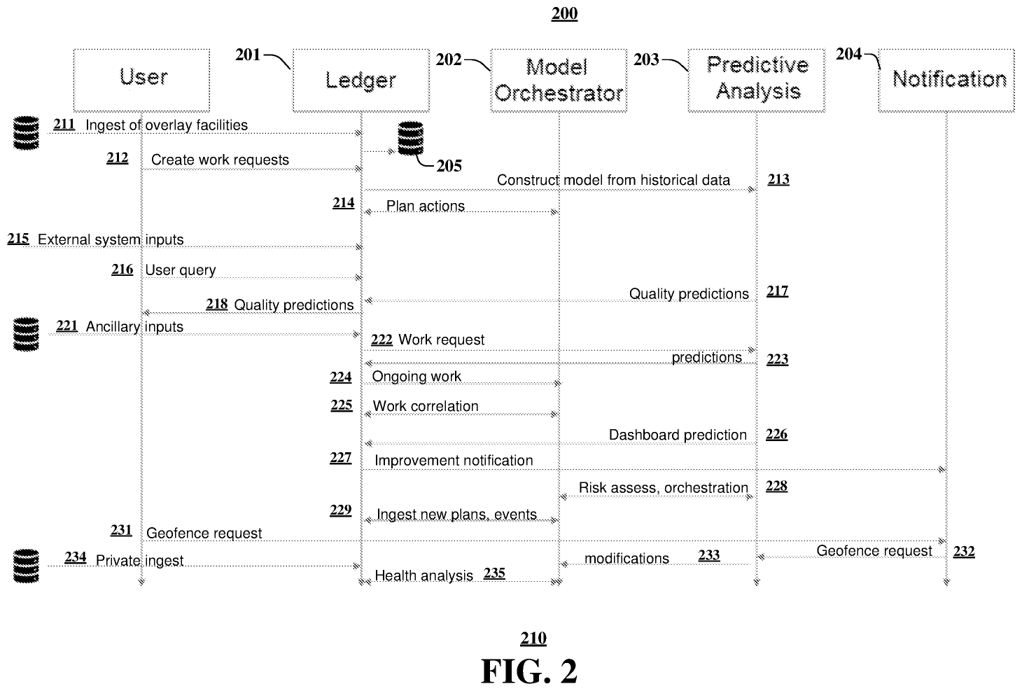

FIG. 2 is a block diagram illustrating an example, non-limiting embodiment of a system functioning within the communication network of FIG. 1 performing a method of assessing and balancing service level agreements (SLAs) for facility infrastructure in accordance with various aspects described herein. Service level agreements, such as uptime for example, often include measures of system reliability. As an illustration, fine nines or 99.999% availability allows for about five minutes or less of downtime per year. Thus, the system can be made aware of these requirements, which may affect future predictions and prescriptive actions for early replacement of facilities which may not have reached a failure point and instead are demonstrating other features of fatigue or decreased performance. As shown in FIG. 2, system 200 comprises several modules including a work, event and audit ledger, or ledger 201, a model orchestrator 202, a predictive analysis module 203, and a notification module 204, collectively referred to as modules. Such modules may be implemented in cloud-based network elements, such as network elements 150, 152, 154 and 156 illustrated in FIG. 1. The system also includes persistent memory storage, hereinafter referred to as database 205.

System 200 is in communication with database 205 and can store and retrieve information for presentation to a user, for example from database 205. System 200 is also in communication through a network where system 200 can acquire information about facility infrastructure from various sources such as external systems, both publicly available on the Internet, and through private information storage of entities associated with the facilities infrastructure. The system provides facilities scoring and reliability models for neighborhood and service companies, such as construction, and informative user bases, such as insurance, planning, etc. System 200 provides event-based and preemptive and notification for facility events—discovery and predictive request for work on failing areas or adjacent potential fails based on work in an area, and predictive notification based on a major event, such as an emergency, outage, etc. System 200 provides planning guidance and orchestration of construction events, i.e., an intelligent way to validate minimal disruption of service based on submission by construction or industry.

Method 210 begins in step 211 where ledger 201 ingests an overlay of facilities infrastructure data from various sources, such as facilities owners, operators, or publicly available information, including government sources. Such facilities infrastructure data comprises several types of facilities data, such as power distribution, telecom, cellular, cable, water, sewer, etc. and the location of the infrastructure thereof. The facilities infrastructure data includes the location of facilities (e.g., a map identifying where each buried line, cable, etc. runs from a central location to a distribution hub providing the services to a premises), a quality of the services provided (e.g., the capacity and speed provided by the service), an extent of service interruptions when the facilities are damaged, repair costs and outage lengths, etc. In one embodiment, the system ingests existing infrastructure installation data that indicate the time of installation, last service, material type, and location. In another embodiment, service level data (e.g., throughput of data on a telecommunications line, throughput of water or gas on a hard facility pipe, or number of errors on any of these facilities) may be added via automated systems or from home-adjacent inspection and metering tools (e.g., meters, residential gateways, self-reporting mobile applications, etc.). In yet another embodiment, the system ingests third-party data that has been constructed via automatic means or via external observations and aggregations, such as specification and placement information via geolocation tables (e.g., location-attributed rows), via ad-hoc or intermitted updates. Ledger 201 stores the facilities infrastructure data in database 205.

Next, in step 212, ledger 201 accepts work requests and outage reports from facilities managers and users, respectively. Hence, system 200 develops an awareness of historical and current operational and maintenance activity of the facilities infrastructure, such as outages, faults, etc.

Next in step 213, predictive analysis module 203 uses machine learning (ML) to construct a composite model for the facilities from the facilities infrastructure data. In an embodiment, the composite ML model is trained with historical availability data (such as broadband uptime), the performance data of the facility, and the number and type of home-centric errors to correlate data with events to render a neighborhood service coverage score that provides an indication of the type and quality of facilities infrastructure available in an area, such as high-speed Internet, wireless telecommunications, water quality, electric capacity, etc. The composite ML model can also provide a neighborhood “reliability” score or a neighborhood “fitness” score that can be provided to potential home buyers to augment their criteria when selecting a new home in a particular neighborhood. In one embodiment, classifier models such as gradient boosted trees (GBT) or random forests (RF) may be utilized to correlate the features (both numerical and categorical in nature) and the discrete labels (e.g., a binary failure or non-failure indicator) or continuous labels (e.g., the fitness, health, quality, or other reliability metric) in a probabilistic prediction or regression (in the case of a continuous label space). In one example, a similar model formulation to Gradient boosted trees that also integrates time-sensitive data is a discrete Fourier transform integrated with XGBoost (Extreme Gradient Boost). In this embodiment, an observed target may be expressed as

ŷᵢ=Σₖ₌₁^{K}gₖ(Fᵢ)

where

Fᵢ={f₀, f₁, . . . , f_{[(n-1)/2]}}

are the associated features used to predict the target, and gₖ∈G represents the trees computed with the model. If analysis of feature importance indicates that fₘ is one of the most important features (while T=1 day), this may indicate that a cycle of m days or (n-m) days may be of interest. In another embodiment models with specific time-sensitivity to the change of features like ARIMA (Autoregressive integrated moving average), LSTMs (Long short-term memories), or transformer models may be utilized to better account for both short- and long-term cyclical behaviors of features. Specifically, LSTMs and transformer models are deep neural network variants that not only create their own feature space (derived from repeated exposure to new samples), but also learn to how to weight recursive model topologies that are intrinsic in the models' hierarchical composition. In yet another embodiment, graphical neural networks may be utilized to incorporate the various features of a facility with those that are connected to it (either by physical proximity or other connectivity for delivery of a service); where the graphical neural network may serve both as a learned model and as a database 205 for probabilistic query responses. In current forms, graphical neural networks may need augmentations provided by other learning frameworks because of their inherent size and longer compute times. Thus, in another embodiment still, the combination of one or more of these models may be created to accommodate both needs for a more immediate and instantaneous “health” assessment and a longer term (or regional) “fitness” score.

Next in step 214, the system plans preemptive actions for facilities in different areas. The composite ML model can provide facility MTBF estimates that disentangles facility quality and ongoing or planned work in area. In one embodiment, facility failures may be the combination of multiple problems like aging infrastructure, but additional learnings by the ML model may actually indicate increased downtime and failures caused by a local abundance of construction accidents. In an embodiment, facilities infrastructure entities can use the MTBF estimates to help select new prospect areas for overbuilding infrastructure, based on, for example, historical outage issues. Cities can use SLA summary results (broadband uptime or throughput performance versus contractual guarantees with one or more homes in a particular neighborhood) to study low-performing areas for possible government grants to improve facilities infrastructure, e.g., converting an old aerial plant to underground facilities. Furthermore, the composite ML model can help stage emergency responders for timely reaction to predicted failures. Through these model predictions, the system has the ability to help monitor customers with SLAs and will recommend routing modifications, if possible.

Then in step 215, system 200 may also receive recent facilities data such as facility performance data from automated testing, performance data from user-based testing on mobile devices, infrastructure assessments from visual or structural analysis, and timestamped visual imagery from direct user contributions or automated contributions of other systems, e.g., Internet of Things (IoT) scans or transient robotics.

Next in step 216, system 200 receives a query from a user and responds using the data and model evaluation developed. In one example, a potential homebuyer queries the system for broadband uptime metrics in the neighborhood to validate suitability for remote learning or home office needs. In another example, a municipality or additional broadband provider queries for potential overbuild projects to identify where facility capacity or performance is underserving customers in the area or is predicted to do so within a timespan provided within the query. In yet another example, streaming content providers such as Netflix query the system because to validate a viewership drop which they suspect is a broadband reliability issue.

Next in step 217, quality of facilities in area—ML can predict quality based on recent facilities data such as last service level, need for replacement, amount of work items in area. Optionally, can include connectivity data or complaint data from consumer side (e.g., a consumer call to report problems, i.e., 311) to correlate subjective items. Optionally, the system can solicit opinions from users via digital polling.

Then in step 218, ledger 201 forwards the quality predictions to the user. In each of the above examples, the system provides data from historical recorded metrics, predicted metrics based on current facility conditions, or both to satisfy the query.

In step 221, ledger 201 receives scores for neighborhoods—comparatively, a good/bad scoring versus neighborhoods with similar coverage. Optionally, ledger 201 can receive information from an ancillary company for facility fitness or reliability (metrics which pertain to outages, uptime, performance, throughput, service frequency, and other descriptive service attributes) to correlate against other data sources, like insurance correlation to home value, crime, etc.

In step 222, the system may utilize predictive analysis module 203 for a work request to identify which facilities (or area of containing facilities) may most benefit from additional repairs or upgrades. In one example, the request to predictive analysis module 203 may contain an optimization request that indicates repairs, upgrades, or full replacements. In another example, the request may contain optimization requests for optimal allocation of a budget, as part of a capital revitalization project.

In step 223, the predictive analysis module 203 utilizes the trained composite ML model to generate predictions that are specific to optimization parameters and format details of the request of step 221. In one example, predictive analysis module 203 generates facility identifiers and geographical information as part of the prediction to describe the next, most likely to fail facilities. In another example, predictive analysis module 203 may return cost aggregations for required current and expected work items in the prediction. In yet another example, insurance companies can use the request to predictively fill actuarial tables for estimation of risk. Here, neighborhoods with poor broadband uptime are at higher risk for crime or other issues like water or fire damage because IoT sensors are not active during downtime. In still another example, government safety agencies can use the request to determine if crime in a particular neighborhood is high due to unreliable broadband. In all of these examples, the predictions from the predictive analysis module 203 may be utilized by the system directly (as in steps below) or returned to the user for subsequent analysis (not illustrated in FIG. 2).

In step 224, the system continuously observes ongoing work items and actions as they apply to different known facilities. These work items may originate from a predetermined workflow created in step 212 or as a response to the returned predicted analysis from step 223.

In step 225, the system correlates work in particular geographic areas to reduce effects on other facilities. System 200 is aware of SLA agreements for the impacted facilities in a geographic area and can plan to minimize impact on the surrounding homes and businesses. Where certain SLA agreements are not pre-specified, system 200 may estimate amounts of facility outage, performance degradation, etc. to approximate conditions for an acceptable impact on the geographic area. In one example, system 200 can schedule a specific telecommunication facility for repair but use the model orchestrator 202 to preemptively schedule rerouting telecommunications traffic in a manner that minimizes violation of an SLA that describes overall intermittent uptime during a winter storm. In another example, model orchestrator 202 may generate facility improvement scenarios where mistakes could impact an unusually large area, such as the replacement of a critical telecommunications backhaul or capacity upgrade of a water treatment facility.

In step 226, the predictive analysis module 203 provides summarized predictions according to optimization parameters defined in step 222 and of the same format as those predictions in step 223 to a dashboard in ledger 201. In one example, this dashboard may be persisted and utilized only by digital actors (such as robots, facility excavators, or billing and project management systems) or by users who initiated work requests in step 212 (flow to user not illustrated in FIG. 2). Optionally, the system could solicit customers to find customer impact data for the predicted outage.

In step 227, the system identifies poor service areas, e.g., in wireless, areas of coverage, and provides such areas for improvement to notification module 204. Utilizing the dashboard update of step 226, a notification regarding a predicted outage is sent to the notification module 204. In one example, notification module 204 broadcasts an alert message to broadband and wireless providers of reliability issues. In another example, the notification broadcast may be received and aggregated by a city infrastructure for quick reference by other public information systems, like 311, or emergency information systems, like 911.

In step 228, which may be executed simultaneously with step 226 or simultaneously with step 223, system 200 assesses risk of performing large operations and orchestrates such operations based on the risk. The system receives work requests from multiple companies and develops a plan to prevent or minimize interruptions to services provided by the facilities infrastructure. In one example, model orchestrator 202 may override or modify ongoing work from step 224 or trigger additional predictions according to subsequent work correlations in step 225.

In step 229, system 200 or a facilities owner requests a survey after a major event (e.g., earthquake, flood). The system can coordinate broadcast notices of some localized events. Optionally, the system can give constraints to automated work dispatch (e.g., weight limits in area, notification of poor access to facility).

Next in step 231, the system allows customer or company to geofence a particular area for faster dispatch of repair personnel or identification of current work in the area. Geofencing allows a user to specify certain geographic areas (street, neighborhood, sub-neighborhood, zip code, town, county, etc.) in which the system may alter ongoing work and its correlation (steps 224 and 225), send immediate and prioritized notifications from step 227, or decrease the acceptable risk levels utilized in step 228. In one example, a geofence is placed around a civil building, such as a courthouse, hospital, or congressional building, to indicate a work with high sensitivity to potential facilities modifications.

In step 232, system 200 may accept an incoming geofence request from notification module 204 that originated from a user as part of step 227.

In step 233, the geofence request from step 232 could modify an optimization criterion utilized in the predictive analysis module 203. In one example, acceptable orchestration steps may be modified or reprioritized based on the modified predictive responses from predictive analysis module 203. In one example, work requests that are within a geofence from step 231 may be automatically accepted (immediate repair) or denied (high predicted impact to SLAs) by the system. In another example, system 200 may schedule an emergency orchestration to reroute facility usage in the geofenced area to maintain adherence to an SLA as in step 225.

In step 234, system 200 receives private/public contributions such as data from various sources such as an IoT smart grid meter, smart Wi-Fi routers, or an enterprise such as the power or gas company, for refinement. This data may augment prior information by augmentation or alternate data layers. In one example, data may update the facilities in an area to indicate not only the presence of buried power transmission lines, but also buried fiber optic communication lines. In another example, civil activities such as the declaration of a state of emergency for a winter storm may add data to indicate the failure or destruction of previously available facilities.

In step 235, system 200 adds a “freshness” and “health” qualifications to the neighborhood fitness and reliability scores from step 213. In one example, freshness is an indicator that the elapsed time (either as an absolute number or as a relative number in comparison to adjacent facilities) of a facility work item that involved reconstruction, rehabilitation, or other general improvements. In another example, the health of one or more facilities in a geographic location or region may receive additional data describing relative fitness and reliability scores. Here, the health descriptions may provide more interpretable values of MTBF or may provide overall failure estimations for a larger region.

Existing methods for facility comparisons are often siloed by service provider or facility type. This disclosure provides for combining each of the facilities together and deriving model-driven leanings from the combination. Such predictive capabilities are often relegated to subject matter experts who may only have partial information and may also lack the time or experience to collect the vast historical data and facility specific readings that are maybe too complex to rationalize without the assistance of high-dimensional machine learning models. Further, existing methods are often reactive in nature and thus lack the coordination that this proposal provides through understanding and scheduling of facilities operations. For example, a power facility may execute quarterly reviews of facility health, but this timing may not be synchronized with telecommunications reviews or additional build out plans. Instead, the model orchestrator 202 coordinates individual work items with ledger 201 and predictive analysis module 203 provides a predictive view of any impact those work items may have, which will better serve both the collective facility providers as well as their customers to minimize disruption to services for deeper engagement while fulfilling contractual obligations and service level agreements for uptime and throughput metrics. While for purposes of simplicity of explanation, the respective processes are shown and described as a series of blocks in FIG. 2, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

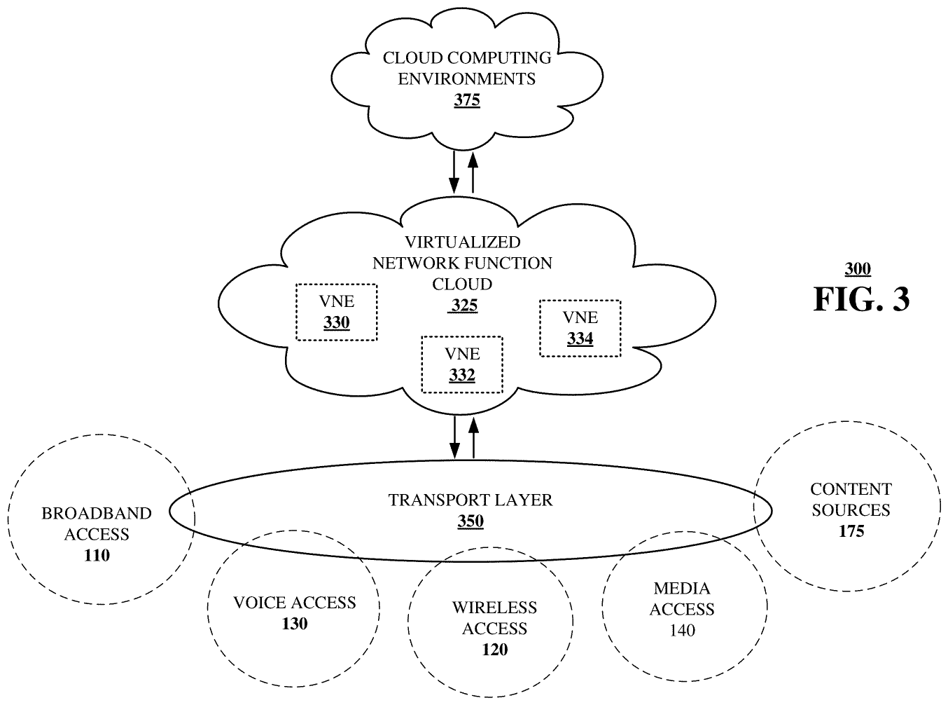

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 210 presented in FIGS. 1, 2 and 3. For example, virtualized communication network 300 can facilitate in whole or in part constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

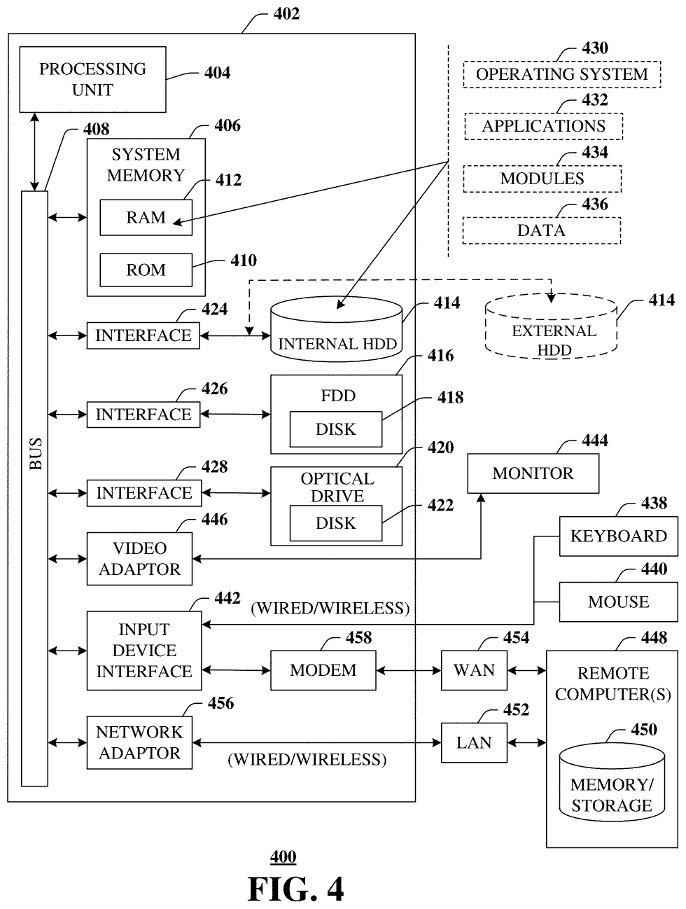

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Non-transitory, machine-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

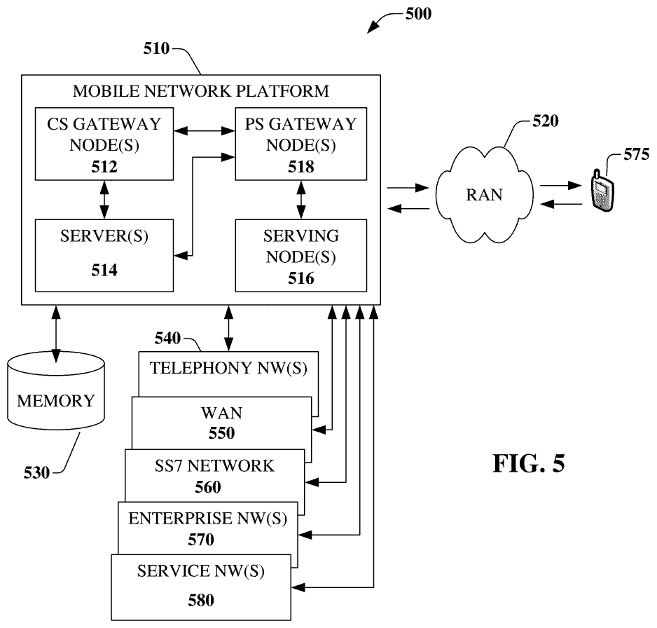

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

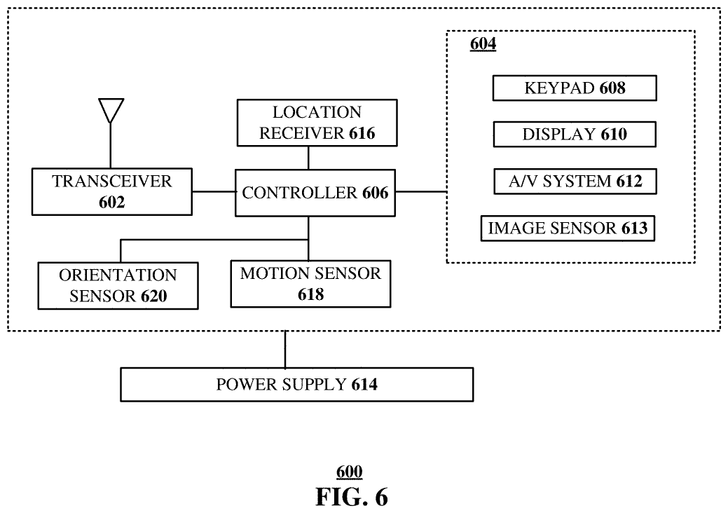

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part constructing a composite machine-learning (ML) model for facilities infrastructure from facilities infrastructure data; training the composite ML model with historical availability data, historical performance data, and historical error rates, wherein the composite ML model yields quality of the facilities infrastructure; receiving a query of a facility in an area from a user; predicting a quality of the facility based on recent facilities data using the composite ML model; and providing the quality of the facility responsive to the query.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
constructing a composite machine-learning (ML) model for facilities infrastructure from facilities infrastructure data;
training the composite ML model with historical availability data, historical performance data, and historical error rates, wherein the composite ML model yields quality of the facilities infrastructure;
receiving a query of a facility in an area from a user;
predicting a quality of the facility based on recent facilities data using the composite ML model; and
providing the quality of the facility responsive to the query.

2. The device of claim 1, wherein the facilities infrastructure data comprises facility performance data from automated testing, performance data from user-based testing on mobile devices, infrastructure assessments from visual or structural analysis, and timestamped visual imagery.

3. The device of claim 1, wherein the quality of the facility includes one or more of a neighborhood service coverage score, a neighborhood reliability score, a neighborhood fitness score, or a facility mean time between failure (MTBF) estimate.

4. The device of claim 1, wherein the recent facilities data includes a last service level, a need for replacement, or an amount of work items in the area.

5. The device of claim 4, wherein the recent facilities data includes connectivity data or complaint data from consumers of the facility.

6. The device of claim 4, wherein the recent facilities data includes customer impact data from a predicted outage.

7. The device of claim 1, wherein the operations further comprise receiving work requests for the facility and providing summarized predictions to a dashboard.

8. The device of claim 1, wherein the processing system comprises a plurality of processors operating in a distributed computing environment.

9. A non-transitory, machine-readable medium, comprising executable instructions that, when executed by a processing system including a processor, facilitate performance of operations, the operations comprising:
constructing a composite machine-learning (ML) model for facilities infrastructure from facilities infrastructure data;
training the composite ML model with historical availability data, historical performance data, and historical error rates, wherein the composite ML model yields quality of the facilities infrastructure;
receiving a query of a facility in an area from a user;
predicting a quality of the facility based on recent facilities data using the composite ML model; and
providing the quality of the facility responsive to the query.

10. The non-transitory, machine-readable medium of claim 9, wherein the facilities infrastructure data comprises facility performance data from automated testing, performance data from user-based testing on mobile devices, infrastructure assessments from visual or structural analysis, and timestamped visual imagery.

11. The non-transitory, machine-readable medium of claim 9, wherein the quality of the facility includes one or more of a neighborhood service coverage score, a neighborhood reliability score, a neighborhood fitness score, or a facility mean time between failure (MTBF) estimate.

12. The non-transitory, machine-readable medium of claim 9, wherein the recent facilities data includes a last service level, a need for replacement, or an amount of work items in the area.

13. The non-transitory, machine-readable medium of claim 12, wherein the recent facilities data includes connectivity data or complaint data from consumers of the facility.

14. The non-transitory, machine-readable medium of claim 12, wherein the recent facilities data includes customer impact data from a predicted outage.

15. The non-transitory, machine-readable medium of claim 9, wherein the operations further comprise receiving work requests for the facility and providing summarized predictions to a dashboard.

16. The non-transitory, machine-readable medium of claim 9, wherein the processing system comprises a plurality of processors operating in a distributed computing environment.

17. A method, comprising:
constructing, by a processing system including a processor, a composite machine-learning (ML) model for facilities infrastructure from facilities infrastructure data;
training, by the processing system, the composite ML model with historical availability data, historical performance data, and historical error rates, wherein the composite ML model yields quality of the facilities infrastructure;
receiving, by the processing system, a query of a facility in an area from a user;
predicting, by the processing system, a quality of the facility based on recent facilities data using the composite ML model; and
providing, by the processing system, the quality of the facility responsive to the query.

18. The method of claim 17, wherein the facilities infrastructure data comprises facility performance data from automated testing, performance data from user-based testing on mobile devices, infrastructure assessments from visual or structural analysis, and timestamped visual imagery.

19. The method of claim 17, wherein the quality of the facility includes one or more of a neighborhood service coverage score, a neighborhood reliability score, a neighborhood fitness score, or a facility mean time between failure (MTBF) estimate.

20. The method of claim 17, wherein the recent facilities data includes a last service level, a need for replacement, or an amount of work items in the area.
